(19) United States
(12) Patent Application Publication
(10) Pub. No.: US 2016/0007026 A1
(43) Pub. Date: Jan. 7, 2016

(54) Techniques for image encoding based on region of interest

(71) Applicants: Jie DONG, Beijing (CN); Weian CHEN, Shanghai (CN); Intel Corporation, Santa Clara, CA (US)

(72) Inventors: Jie DONG, Beijing (CN); Weian CHEN, Shanghai (CN)

(21) Appl. No.: 13/976,425

(22) PCT Filed: Mar. 8, 2013
(86) PCT No.: PCT/CN2013/072363

§ 371 Date: Sep. 12, 2014

(51) Int. Cl. H04N 19/167; H04N 5/232; G06K 9/00; H04N 5/225; H04N 19/176; G06K 9/46; G01B 11/14

(52) U.S. Cl. CPC H04N 19/167; G06K 9/4604; H04N 5/23212; G01B 11/14; H04N 5/2254; H04N 19/176; G06K 9/46; G06K 9/00268

(57) ABSTRACT

Various embodiments are generally directed to the use of a region of interest (ROI) determined during capture of an image to enhance compression of the image for storage and/or transmission. An apparatus includes an image sensor to capture an image as captured data; and logic to determine first boundaries of a region of interest within the image, compress a first portion of the captured data representing a first portion of the image within the region of interest with a first parameter, and compress a second portion of the captured data representing a second portion of the image outside the region of interest with a second parameter corresponding to the first parameter, the first and second parameters selected to differ to compress the second portion of the captured data to a greater degree than the first portion of the captured data. Other embodiments are described and claimed.

### TECHNICAL FIELD

Embodiments described herein generally relate to using a region of interest within a field of view of a captured image in compressing the image.

### BACKGROUND

The increasing color depth and resolution with which both still and motion video imagery is captured, stored and viewed digitally has enabled digital photography to match the quality of film-based photography at even a professional level in which expectations of sharpness and color reproduction are heightened. However, increases in both color depth and resolution also result in increased data sizes for each image. This brings about both increased storage capacity requirements for storage devices and increased data transfer rate requirements for the exchange of data that includes such images.

In answer to these increased requirements, increasing emphasis has been placed in the area of image compression technologies that encode either individual images or sets of images of motion video to reduce their data sizes. Some image compression technologies employ lossless encoding algorithms in which commonly observed characteristics of image data are employed to reduce data size in a manner that does not discard any data for any pixel of an image. Although lossless encoding algorithms enable image data to be faithfully reproduced when subsequently uncompressed, they typically achieve little more than reducing the data size of an image by about half.

Other image compression technologies employ lossy encoding algorithms in which aspects of human vision are taken into account to discard portions of the data of an image that contribute less to the perception of that image by the human eye and/or visual cortex than other portions of that data. In essence, there is a selective removal of data deemed less likely to be noticed as missing than other data. Such lossy encoding algorithms are often able to achieve considerably greater degrees of compression, sometimes reducing the data size of an image to about 1/10th its original data size.

However, as both resolution and color depth continue to increase, an increase in the degree of compression has been deemed desirable. It is with respect to these and other considerations that the embodiments described herein are needed.

### BRIEF DESCRIPTION OF THE DRAWINGS

FIG. 1 illustrates different portions of a first embodiment of interaction among computing devices.

FIGS. 2A and 2B illustrate aspects of image capture in possible implementations of the embodiment of FIG. 1.

FIGS. 3A and 3B illustrate aspects of image encoding in possible implementations of the embodiment of FIG. 1.

FIG. 4 illustrates a portion of the embodiment of FIG. 1.

FIG. 5 illustrates aspects of a variant of the embodiment of FIG. 1.

FIG. 6 illustrates an embodiment of a first logic flow.

FIG. 7 illustrates an embodiment of a second logic flow.

FIG. 8 illustrates an embodiment of a third logic flow.

FIG. 9 illustrates an embodiment of a processing architecture.

### DETAILED DESCRIPTION

Various embodiments are generally directed to the use of a region of interest (ROI) determined during capture of an image to enhance compression of the image for storage and/or transmission. Data indicating boundaries of a region of interest of an image that is known at or about the time the image is captured is stored within the capture device. The indication of these boundaries of the region of interest is subsequently used during compression of data representing the captured image to cause compression of the portion of the image within the region of interest to be performed differently than another portion of the image outside the region of interest.

More specifically, a portion of the captured image outside the region of interest is compressed using one or more parameters selected to achieve a higher degree of compression at the expense of quality of image in that portion when subsequently decompressed and viewed. In contrast, the portion of the captured image within the region of interest is compressed using one or more parameters selected to achieve a higher quality of image in that portion for subsequent decompression and viewing at the expense of degree of compression. Employing such a difference in the compression of the portion of the captured image within the region of interest versus a portion of the captured image outside the region of interest enables more aggressive compression of the data representing the portion outside the region of interest to achieve a smaller overall data size, while still allowing the region of interest to maintain a higher image quality.

The boundaries of the region of interest of an image are determined at or about the time the image is captured. Those boundaries may be determined automatically by the capture device as part of implementing an automated form of focusing, or controls of the capture device may be operated to specify those boundaries. It should also be noted that there may be more than one region of interest in a captured image, each with its own boundaries. Further, it should be noted that such use of a region of interest is not limited to the capturing of a single or “still” image, as one or more regions of interest may be specified for the frames captured in the capturing of motion video.

It is envisioned that, at least in some embodiments, the capturing of an image and the compression encoding of the data representing that image are both performed by the capture device. However, other embodiments are possible in which the capture device is split into two portions or devices, a first portion or device that captures the image and a second portion or device that employs a compression encoding algorithm that uses data indicating the boundaries of a region of interest to compress data representing the captured image, both of which are received from the first device.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may incorporate a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

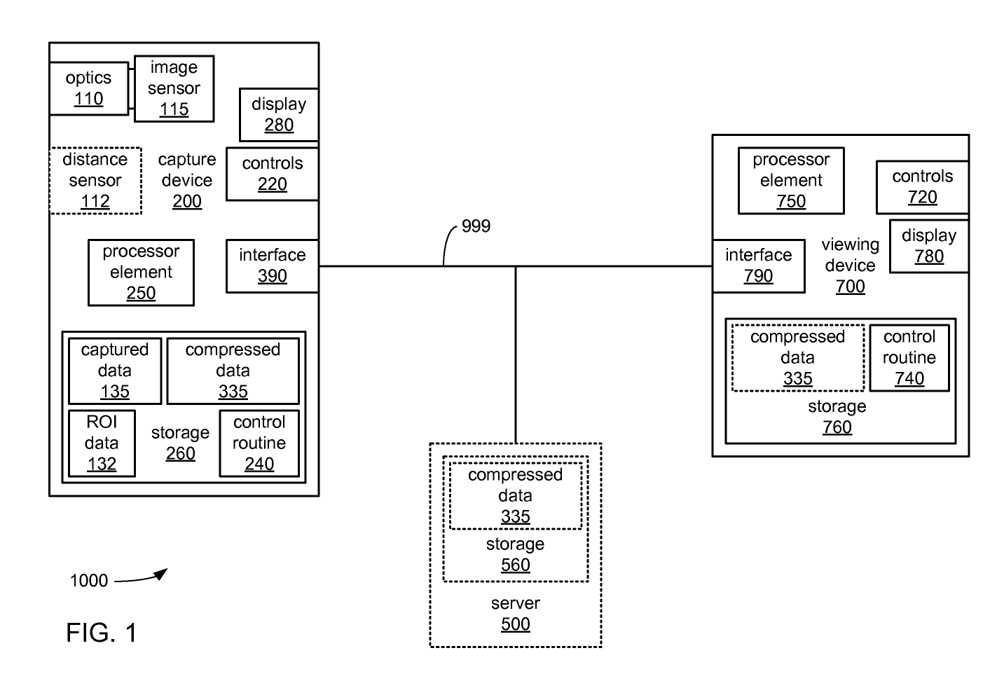

FIG. 1 depicts a block diagram of interactions among computing devices of an image handling system 1000 comprising a capture device 200 to capture and compress an image, a viewing device 700 to decompress and view the image, and possibly a server 500 to at least temporarily store data representing the image as compressed. Each of these computing devices 200, 500 and 700 may be any of a variety of types of computing device, including without limitation, a desktop computer system, a data entry terminal, a laptop computer, a netbook computer, an ultrabook computer, a tablet computer, a handheld personal data assistant, a smartphone, a digital camera, a mobile device, a body-worn computing device incorporated into clothing, a computing device integrated into a vehicle, a server, a cluster of servers, a server farm, etc.

As depicted, these computing devices 200, 500 and 700 exchange signals conveying data representing captured images, compressed or not, along with data indicating one or more regions of interest through a network 999. However, one or more of these computing devices may exchange other data entirely unrelated to images or regions of interest. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission. It should also be noted that such data may alternatively be exchanged at least between the computing devices 200 and 700 via direct coupling of a removable storage (e.g., a solid-state storage based on FLASH memory technology, an optical disc medium, etc.) at different times to each.

In various embodiments, the capture device 200 incorporates one or more of a processor element 250, a storage 260, controls 220, a display 280, optics 110, a distance sensor 112, an image sensor 115, and an interface 390 to couple the capture device 200 to the network 999. The storage 260 stores one or more of a control routine 240, ROI data 132, captured data 135, and compressed data 335. The image sensor 115 may be based on any of a variety of technologies for capturing an image of a scene, including and not limited to charge-coupled device (CCD) semiconductor technology. The optics 110 is made up of one or more lenses, mirror, prisms, shutters, filters, etc. The optics 110 is interposed between the image sensor 115 and a scene such that the image sensor is provided with a view of the scene to be captured through the optics 110. Thus, light emanating from a scene is conveyed to the image sensor 115 through the optics 110. Characteristics of the optics 110 and of the image sensor 115, together, cooperate to define a field of view of the capture device 200.

In some embodiments, the optics 110 may provide the ability to controllably alter the focus of the light of a scene that the optics 110 conveys to the image sensor 115, which may correspondingly alter the field of view. In such embodiments, the optics 110 may incorporate one or more lenses and/or reflective surfaces that are movable and/or alterable in their shape. Also, in such embodiments, the capture device 200 may incorporate the distance sensor 112 to be used in conjunction with the optics 110 to enable automated control of focus. If present, the distance sensor 112 may be based on any of a variety of technologies for determining at least the distance of at least one object in the field of view from the capture device 200. In some embodiments, a combination of ultrasonic output and reception may be used in which at least such a distance may be determined by projecting ultrasonic sound waves towards that object and determining the amount of time required for those sound waves to return after being reflected by that object. In other embodiments, a beam of infrared light may be employed in a similar manner in place of ultrasonic sound waves. Still other technologies to determine the distance of an object from the capture device 200 will occur to those skilled in the art.

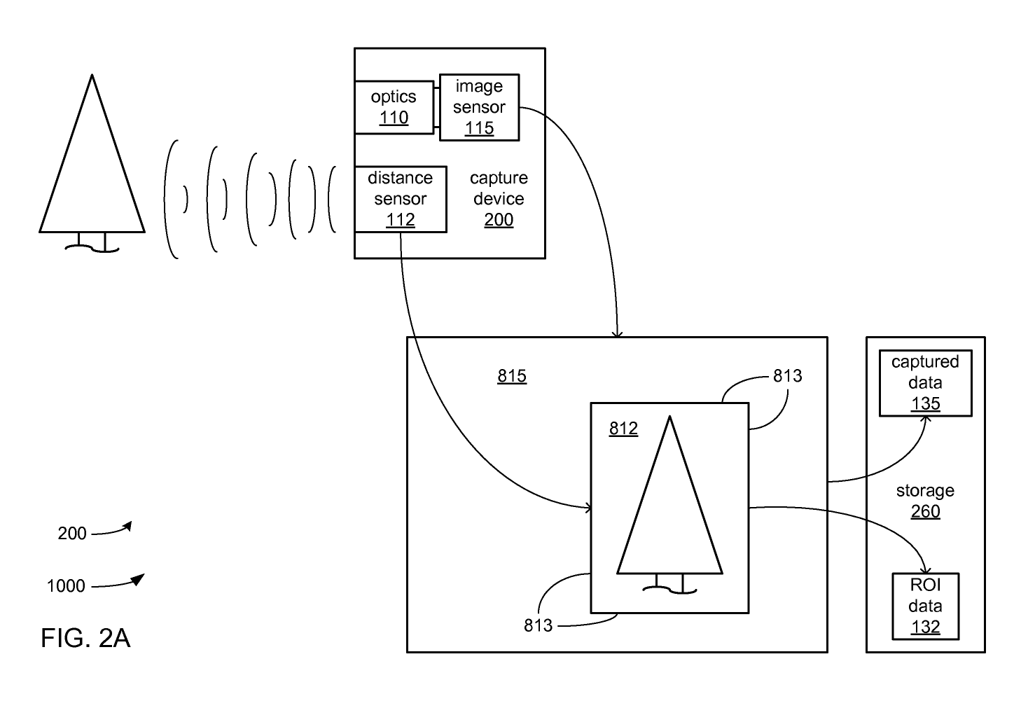

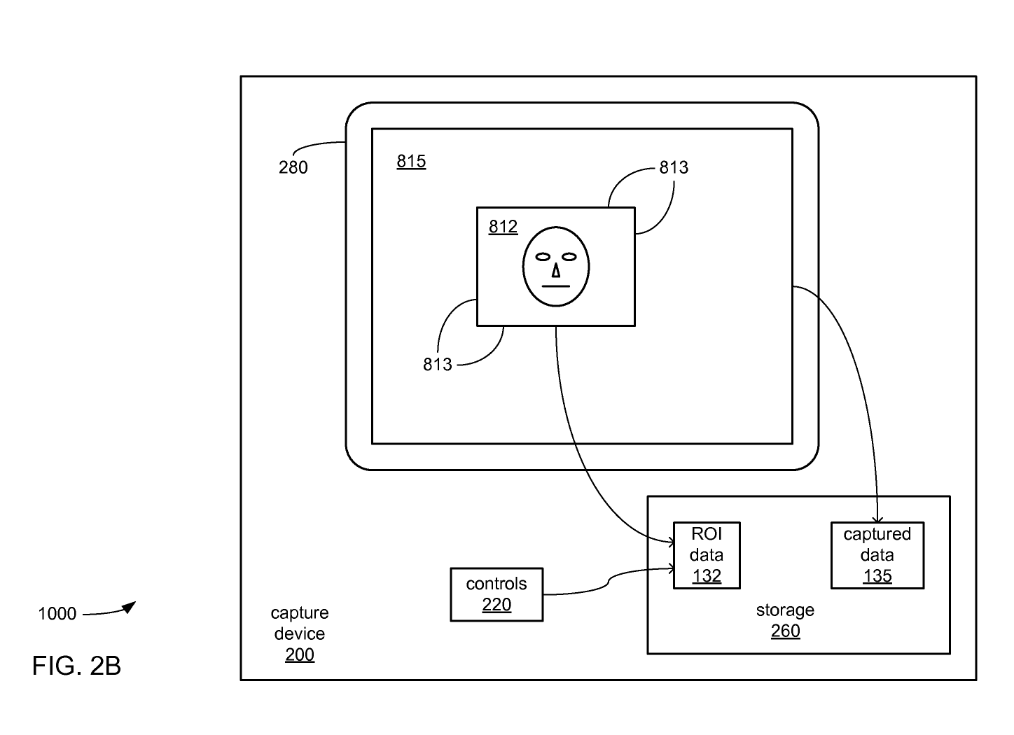

In executing a sequence of instructions of the control routine 240, the processor element 250 is caused to await a trigger signal conveying a command to the capture device 200 to operate at least the optics 110 to automatically adjust focus and/or to operate at least the image sensor 115 to capture an image. The trigger signal may be received from the controls 220 and represent direct operation of the controls 220 by an operator of the capture device 200, or the trigger signal may be received from another computing device (not shown), possibly via the network 999. Aspects of such automated focusing and capture of an image are depicted in FIGS. 2A and 2B.

Turning to FIG. 2A, in some embodiments supporting automated focus, the processor element 250 operates the distance sensor 112 to determine the distance between the capture device 200 and an object in a field of view 815 of the image sensor 115 through the optics 110. The processor element 250 then operates the optics 110 to adjust the focus for this determined distance. In some possible implementations, the distance sensor 112 may be operated to determine the distance from the capture device 200 to the object in the field of view 815 that is closest to the capture device 200. In such implementations, the distance sensor 112 may have some ability to be used to determine the location and size of that closest object is in the field of view 815, and the processor element 250 may determine the boundaries 813 of a region of interest 812 that encompasses the location of at least a portion of that closest object within the field of view 815 as detected by the distance sensor 112. In other possible implementations, the distance sensor 112 may be operated to determine the distance between the capture device 200 and the object in the center of the field of view 815, regardless of the distance between the capture device 200 and any other object in the field of view. Such implementations may reflect a presumption that at least the majority of images captured with the capture device 200 will be centered on an object of interest to whoever operates the capture device 200. In such implementations, the location of the region of interest 812 may be defined as being at the center of the field of view 815 by default. However, the distance sensor 112 may have some ability to be used to determine size and/or shape of the object in the center of the field of view 815, thereby enabling the processor element 250 to determine the degree to which that object fills the field of view 815 and ultimately enabling the processor element 250 to determine the boundaries 813 of the region of interest 812 in the center of the field of view 815.

Thus, in such implementations, the distance sensor 112 may be used as an aid to determining the boundaries 813 of the region of interest 812 in addition to enabling a determination of distance to an object for automated focus. The processor element 250 stores an indication of the boundaries 813 of the region of interest 812 within the field of view 815 as the ROI data 132 for subsequent use in compression. With the focus adjusted, and regardless of exactly how the focus is adjusted, the processor element 250 is caused by execution of the control routine 240 to operate the image sensor 115 to capture an image of what is in the field of view 815. It should be noted that this captured image may be a single or “still” image, or it may be one of multiple images or a “frame” of multiple frames of a captured motion video. In so operating the image sensor 115, the processor element 250 receives signals from the image sensor 115 conveying the captured image as detected by the image sensor 115, and the processor element 250 stores the captured image as the captured data 135.

However and turning to FIG. 2B, in alternate implementations, the distance sensor 112 may have no role in determining the boundaries 813 of the region of interest 812 within the field of view 815. In some possible embodiments, the processor element 250 may be caused to employ one or more algorithms to analyze objects in the field of view 815 to attempt to identify one or more particular types of objects based on a presumption that those types of objects are likely to be of interest to whoever is operating the capture device 200. Thus, for example, the processor element 250 may be caused to employ a face detection algorithm to search for faces in the field of view 815. Upon identifying a face in the field of view 815, the processor element 250 may be caused to define the boundaries 813 of the region of interest 812 to encompass that identified face. The processor element 250 may then be caused to operate the distance sensor 112 (if it is present) to determine the distance between the capture device 200 and the object identified as being a face for use in operating the optics 110 to adjust the focus. Again, the processor element 250 is caused to store an indication of the boundaries 813 of the region of interest 812 as the ROI data 132, and to store the image ultimately captured of the field of view 815 as the captured data 135.

In still another alternative, the processor element 250 may receive signals indicative of manual operation of the controls 220 by an operator of the capture device 200 to manually indicate the boundaries 813 of the region of interest 812. Such a manually provided indication may be in lieu of automated determination of those boundaries, may be a refinement of such an automated determination of those boundaries and/or may be to specify the boundaries of an additional region of interest (not shown).

Returning to FIG. 1, and following storage of the ROI data 132 and the captured data 135, the processor element 250 compresses the captured data 135 to create the compressed data 335 using any of a variety of compression encoding algorithms. Where the captured image is a single or “still” image, the processor element 250 may use a compression encoding algorithm associated with an industry-accepted standard for compression of still images, such as and not limited to JPEG (Joint Photographic Experts Group) promulgated by ISO/IEC (International Organization for Standardization and the International Electrotechnical Commission). Where the captured image is one of multiple images making up a portion of motion video (e.g., a frame of motion video), the processor element 250 may use a compression encoding algorithm associated with an industry-accepted standard for compression of motion video, such as and not limited to H.263 or H.264 of various incarnations of MPEG (Motion Picture Experts Group) promulgated by ISO/IEC (International Organization for Standardization and the International Electrotechnical Commission), or VC-1 promulgated by SMPTE (Society of Motion Picture and Television Engineers).

In so compressing the captured data 135, the processor element 250 uses the indication of the boundaries 813 of the region of interest 812 within the field of view 815 of the image represented by the captured data 135 to vary the compression. In so doing, the processor element 250 is caused to compress the portion of the captured data 135 representing the portion of the captured image within region of interest 812 to a lesser degree than a portion of the captured data 135 representing a portion of the captured image of the field of view 815 that is not within the region of interest 812. More precisely, one or more parameters of the compression of the portion of the captured image within the region of interest 812 differ from one or more corresponding parameters of the compression of a portion of the captured image outside the region of interest 812. Such a difference in parameters may include one or more of a difference in color depth, a difference in color encoding, a difference in a quality setting, a difference in a parameter that effectively selects lossless or lossy compression, a difference in a compression ratio parameter, etc.

As a result, the pixels of the captured image within the region of interest 812 are represented with a higher average of bits per pixel in the compressed data 335 created from the compression of the captured data 135 than the pixels of a portion of the captured image that is outside the region of interest 812. Stated differently, more information associated with pixels of a portion of the captured image that is outside the region of interest 812 is lost on average per pixel than is lost on average for the pixels within the region of interest 812. Thus, at a later time when the compressed data 335 is decompressed as part of viewing the captured image, the portion of the captured image within the region of interest 812 is able to be displayed with greater image quality (e.g., displayed with greater detail and/or color depth, etc.).

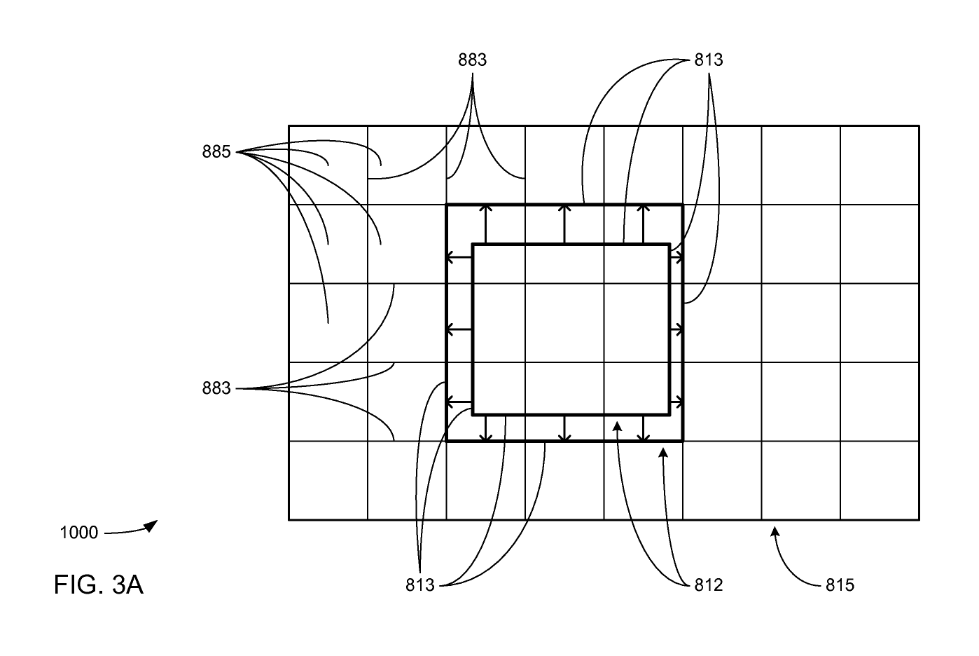

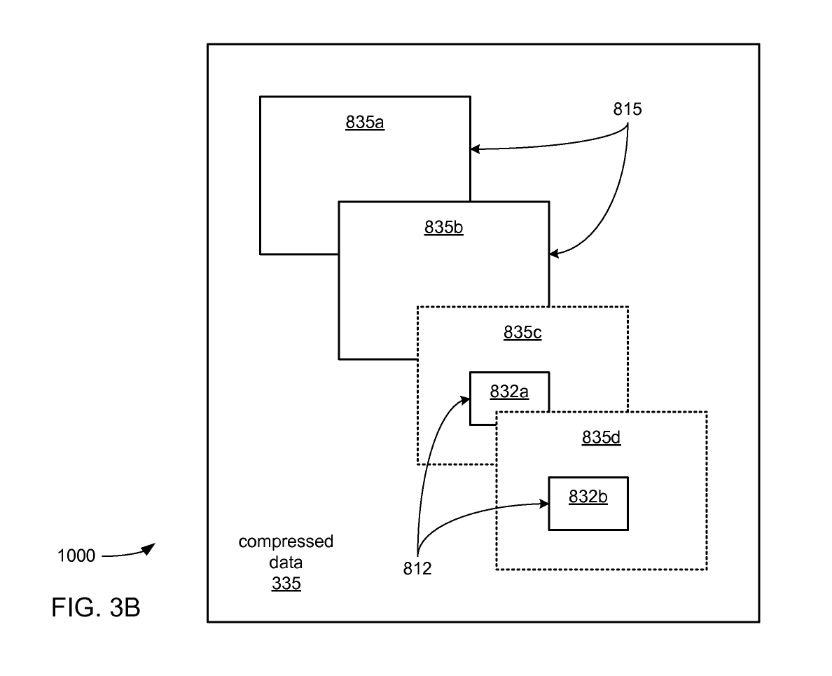

It should be noted that the choice of a compression encoding algorithm associated with an industry standard may result in the imposition of various requirements for characteristics of the compressed data 335. Specifically, such an industry standard likely includes a specification concerning the manner in which portions of the data representing an image in compressed form are organized (e.g., specifying that the data begin with a specific header meeting various requirements of the industry standard, etc.), the order in which data associated with each pixel of an image is organized, limitations on choices of available color depth and/or color encoding, etc. For example and as depicted in FIG. 3A, some compression encoding algorithms entail handling of an image in two-dimensional blocks 885 of pixels called “macroblocks” that are typically 8×8, 8×16 or 16×16 pixels in size (16×16 being more common). Further, of those compression encoding algorithms, some further require organizing the resulting compressed data in a manner in which the pixel data is organized by macroblocks. Still further, some of those compression encoding algorithms require that all pixels within each macroblock be associated with a common color depth, common color encoding and/or other common compression-related parameters such that it is not possible to compress some of the pixels of a macroblock with parameters that differ from other pixels of that same macroblock.

As a result, where the boundaries 813 of the region of interest 812 do not align with boundaries 883 of adjacent ones of the macroblocks 885, the boundaries 813 of the region of interest 812 may be altered by the processor element 250 to align with the boundaries 883. The result is a change in the boundaries 813 of the region of interest 812 to align them with the boundaries 883. In some implementations, the processor element 250 shifts any unaligned ones of the boundaries 813 of the region of interest 812 towards the closest one of the boundaries 883 of adjacent ones of the macroblocks 885, regardless of whether or not doing so increases or decreases the two-dimensional area of the region of interest 812. In other implementations, the processor element 250 shifts any unaligned ones of the boundaries 813 of the region of interest 812 outward to the closest boundaries 883 of adjacent ones of the macroblocks 885 that are outside of the original boundaries 813 of the region of interest 812 such that the two-dimensional area of the region of interest 812 can only increase. This may be done to ensure that an object of interest around which the boundaries 813 of the region of interest 812 may have originally been defined is not subsequently removed (either wholly or in part) from the region of interest 812 as a result of its two-dimensional area shrinking.

As yet another alternative, and presuming that the choice of compression encoding algorithm is known at the time of defining the boundaries 813 to be one in which such macroblocks are used, the boundaries 813 of the region of interest 812 may be initially defined to align with ones of the boundaries 883 of adjacent ones of those macroblocks to avoid having to shift the boundaries 813 at a later time. Regardless of how the boundaries 813 are caused to be aligned with ones of the boundaries 883 of adjacent ones of the macroblocks 885, the fact of their being so aligned enables the different compression parameters employed in compressing the captured image are able to be specified in the compressed data 335 on a per-macroblock basis that follows requirements specified for the compressed data 335 as a result of the choice of compression encoding algorithm that has been made.

Turning to FIG. 3B, it should also be noted that the choice of compression encoding algorithm associated with an industry standard may further include a specification for an option to organize the pixel data in multiple “passes” of the captured image. This is sometimes referred to as “progressive” encoding in which the pixel data is organized to begin with a first relatively low resolution “pass” covering the entirety of the image, followed by one or more subsequent passes that add progressively more detail to the first pass with each additional one of the subsequent passes. This option of progressive passes is meant to allow an image to begin to be viewed more quickly at a viewing device as the image is still being received by that viewing device. In other words, even as more of the data representing an image is being received, the relatively low resolution representation of the image of the first pass is able to be visually presented for viewing immediately upon its receipt, and the visual presentation of the image is progressively enhanced as each subsequent pass is received. This may be seen as desirable to avoid causing an operator of a viewing device to wait for the transfer of data representing the image to the viewing device to be completed before the image may be viewed, at all, where the data size of that data is relatively large and/or where the rate of transfer of that data to the viewing device is relatively slow.

The processor element 250 may be caused by the control routine 240 to take advantage of the option of organizing pixel data within the compressed data 335 in multiple passes by first creating one or more initial passes of pixel data of the entire captured image within the field of view 815 (e.g., the passes 835a and 835b as depicted in FIG. 3B), followed by one or more additional passes made up only of pixel data associated with pixels within the region of interest 812 (e.g., pixel data 832a and 832b of the passes 835c and 835d, respectively, as depicted in FIG. 3B). Thus, the data size of the pixel data making up each of the additional passes 835c and 835d is substantially smaller than the data size of the pixel data making up each of the initial passes 835a and 835b. Indicators of “null” or “transparent” pixel data values for the pixels outside the region of interest 812 in each of the additional passes 835c and 835d may be used to effectively “fill” those pixels in those passes in a manner that adds minimally to the data size of each of those passes.

Returning to FIG. 1, and following compression of the captured data 135 to create the compressed data 335 in a manner employing the indication of the boundaries 813 of the region of interest 812 in the ROI data 132, the processor element 250 may provide the compressed data 335 to one or both of the server 500 for storage and the viewing device 700 to enable viewing of the captured image. The processor element 250 may operate the interface 390 to transmit the compressed data 335 to one or both of the server 500 and the viewing device 700 via the network 999. Alternatively or additionally, the processor element 250 may store the compressed data 335 on a removable storage medium (not shown) that is subsequently carried to one or both of the server 500 or the viewing device 700 where one or both then retrieves the compressed data 335 therefrom.

In various embodiments, the viewing device 700 incorporates one or more of a processor element 750, a storage 760, controls 720, a display 780 and an interface 790 coupling the viewing device 700 to the network 999. The storage 760 stores a control routine 740 and a copy the compressed data 335 received from the capture device 200, either directly or through the server 500. In executing a sequence of instructions of the control routine 740, the processor element 750 is caused to receive and decompress the copy of the compressed data 335. The processor element 750 is then caused to visually present the captured image on the display 780. The processor element 750 may further receive indications of operation of the controls 720 by an operator of the viewing device 700 to convey commands to the viewing device 700 to alter the manner in which the captured image is visually presented (e.g., commands to pan about, zoom into and/or out of the captured image, etc.).

In various embodiments, each of the processor elements 250 and 750 may include any of a wide variety of commercially available processors, including without limitation, an AMD® Athlon®, Duron® or Opteron® processor; an ARM® application, embedded or secure processor; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor elements may include a multi-core processor (whether the multiple cores coexist on the same or separate dies), and/or a multi-processor architecture of some other variety by which multiple physically separate processors are in some way linked.

In various embodiments, each of the storages 260 and 760 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 390 and 790 employ any of a wide variety of signaling technologies enabling each of computing devices 200 and 700 to be coupled through the network 999 as has been described. Each of these interfaces includes circuitry providing at least some of the requisite functionality to enable such coupling. However, each of these interfaces may also be at least partially implemented with sequences of instructions executed by corresponding ones of the processor elements 250 and 750 (e.g., to implement a protocol stack or other features). Where one or more portions of the network 999 employs electrically and/or optically conductive cabling, corresponding ones of the interfaces 390 and 790 may employ signaling and/or protocols conforming to any of a variety of industry standards, including without limitation, RS-232C, RS-422, USB, Ethernet (IEEE-802.3) or IEEE-1394. Alternatively or additionally, where one or more portions of the network 999 entails the use of wireless signal transmission, corresponding ones of the interfaces 190 and 390 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 190 and 390 are depicted as a single block, one or more of these may include multiple interfaces that may be based on differing signaling technologies. This may be the case especially where one or more of these interfaces couples corresponding ones of the computing devices 100 and 300 to more than one network, each employing differing communications technologies.

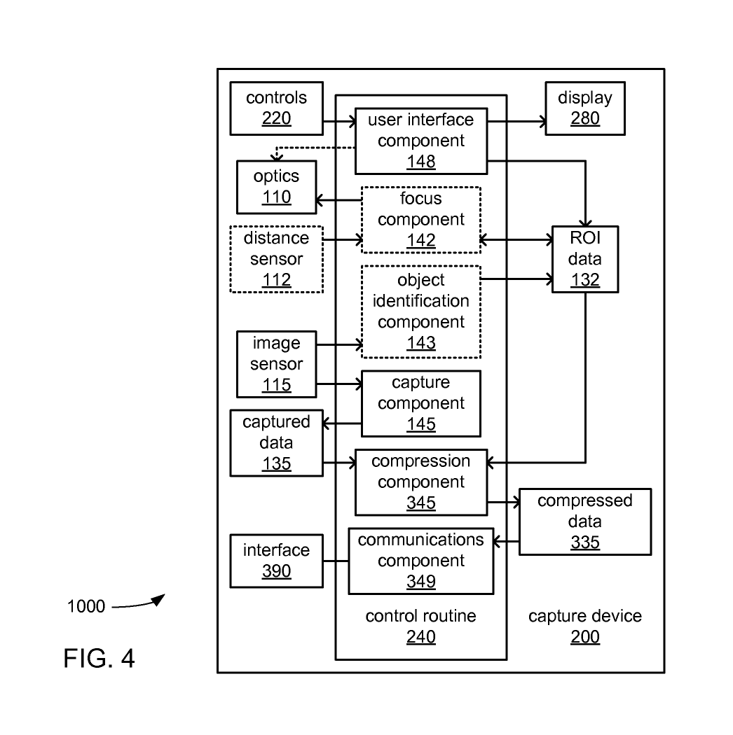

FIG. 4 illustrates a block diagram of a portion of the block diagram of FIG. 1 depicted in greater detail. More specifically, aspects of the operating environment of the computing device 200 is depicted, in which the processor element 250 is caused by execution of the control routine 240 to perform the aforedescribed functions. As will be recognized by those skilled in the art, the control routine 240, including the components of which it is composed, is selected to be operative on whatever type of processor or processors that are selected to implement each of the processor element 250.

In various embodiments, the control routine 240 may include a combination of an operating system, device drivers and/or application-level routines (e.g., so-called “software suites” provided on disc media, “applets” obtained from a remote server, etc.). Where an operating system is included, the operating system may be any of a variety of available operating systems, including without limitation, Windows™, OS X™, Linux®, or Android OS™. Where one or more device drivers are included, those device drivers may provide support for any of a variety of other components, whether hardware or software components, of the computing device 200.

The control routine 240 includes a communications component 349 executable by the processor element 250 to operate the interface 390 to transmit and receive signals via the network 999 as has been described. As will be recognized by those skilled in the art, this communications component is selected to be operable with whatever type of interface technology is selected to implement this interface.

The control routine 240 may include an object identification component 143 executable by the processor element 250 to analyze objects present in the field of view 815 prior to capturing an image of what is in the field of view 815 to attempt to identify at least one type of object therein. As previously discussed, one possible example of a type of object is faces, though it should again be noted that the field of view 815 may be analyzed to attempt to identify other types of objects in lieu of or in addition to faces. Thus, the object identification component 143 may analyze the field of view 815 to attempt to identify the location of a face therein, as well as the size of that identified face within the field of view 815. The object identification component 143 may then use the location and size of that identified face to determine the boundaries 813 of the region of interest 812, storing an indication of those boundaries as the ROI data 132.

The control routine 240 may include a focus component 142 executable by the processor element 250 to operate at least the optics 110 to adjust the focus with which an image is subsequently captured through operation of the image sensor 115. Where the distance sensor 112 is present, the focus component operates the distance sensor 112 to determine the distance between the capture device 200 and an object in the field of view 815. As previously discussed, the object may simply be whatever object is in the center of the field of view, and the distance sensor 112 may additionally be operated to determine the size of that object within the field of view. In such implementations, the focus component 142 additionally determines the boundaries 813 of the region of interest 812, storing an indication of those boundaries as the ROI data 132. Alternatively, as previously discussed, the object may be an object identified by another mechanism by which the boundaries 813 of the region of interest 812 have also been determined, such as the object identification component 143 just discussed above. In such implementations, the focus component 142 receives the boundaries 813 of the region of interest 812 as an input and operates the distance sensor 112 to determine the distance from the capture device 200 to an object within the region of interest 812. Regardless of how exactly an object to which a distance is determined is selected, the focus component 142 then uses the determined distance to operate the optics 110 to adjust the focus accordingly.

The control routine 240 may include a user interface component 148 executable by the processor element 250 to monitor the controls 220 and operate the display 280 to enable an operator of the capture device 200 to directly provide the boundaries 813 of the region of interest 812. The user interface component 148 may operate the display 280 to visually present positions of the boundaries 813 of the region of interest 812 that may have been earlier determined automatically by another mechanism, such as either of the object identification component 143 or the focus component 142 just discussed above. The user interface component 148 receives signals indicative of operation of the controls 220 by the operator of the capture device 200 to indicate the boundaries 813 (whether a revision of earlier automatically derived locations of the boundaries 813, or not) of the region of interest 812, and stores an indication of those boundaries as the ROI data 132. It should additionally be noted that in embodiments where focus is not automatically adjusted, the user interface component 148 may enable an operator of the capture device 200 to directly adjust the focus through operation of the controls 220, either in addition to or in lieu of enabling direct provision of the boundaries 813 of the region of interest 812.

The control routine 240 includes a capture component 145 executable by the processor element 250 to capture an image of what is visible to the image sensor 115 in the field of view 815 following at least adjustment of focus, and stores data representing the captured image as the captured data 135. As has been discussed, the capture of an image may be in response to the same trigger signal that triggers at least automatic focusing. However, in other possible embodiments, such automatic focusing may be triggered by one signal while the actual capturing of an image may be triggered by an additional subsequent signal.

The control routine 240 includes a compression component 345 executable by the processor element 250 to compress the captured data 135 representing the captured image, and thereby create the compressed data 335 with a data size smaller than that of the captured data 135. In so doing, the compression component 345 uses the indication provided by the ROI data 132 of the boundaries 813 of the region of interest 812 to compress portions of the captured data 135 representative of pixels within the region of interest 812 with one or more different parameters than portions of the captured data 135 representative of pixels outside the region of interest 812. As has been previously discussed at length, those parameters are selected to compress a portion of the captured image outside of the region of interest 812 to a greater degree and resulting in a greater loss of pixel data per pixel than the portion of the captured image within the region of interest 812 such that the portion within the region of interest 812 is able to be subsequently viewed with more of its detail preserved. More specifically, and has been previously such a difference in parameters for portions within the region of interest 812 versus portions outside the region of interest 812 may include one or more of a difference in color depth, a difference in color encoding, a difference in a quality setting, a difference in a parameter that effectively selects lossless or lossy compression, a difference in a compression ratio parameter, etc.

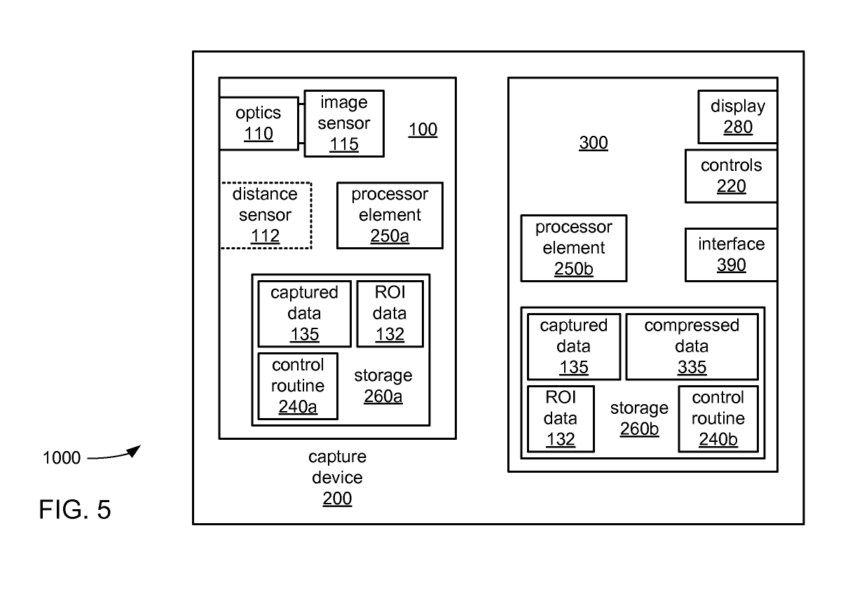

FIG. 5 illustrates a block diagram of a variation of the capture device 200 of FIG. 1. For sake of clarity of depiction and discussion, depictions of the network 999, the server 500 and the viewing device 700 (which were depicted in FIG. 1) have been omitted in FIG. 5. This variation depicted in FIG. 5 is similar to what is depicted in FIG. 1 in many ways, and thus, like reference numerals are used to refer to like elements throughout.

However, unlike the variant of the capture device 200 of FIG. 1, the variant of the capture device 200 of FIG. 5 depicts one possible distribution of components of the capture device 200 into two distinct portions 100 and 300. In this distribution, the processor element 250 and the storage 260 storing the control routine 240 of what is depicted in FIG. 1 are split into separate processor elements 250a and 250b, and into separate storages 260a and 260b storing control routines 240a and 240b, and distributed among the portions 100 and 300, respectively. In this variant of FIG. 5, the processor element 250a, in executing the control routine 240a, may operate the optics 110 and/or the distance sensor 112 to determine and/or adjust for a distance to an object in the field of view 815 from the capture device 200. Also, in this variant, the processor element 250b, in executing the control routine 240b, may compress the captured data 135 to create the compressed data 335, using the indication of boundaries 813 of the region of interest 812 to vary the manner in which different portions of the captured data 135 representing different portions of the captured image are compressed, as has been discussed.

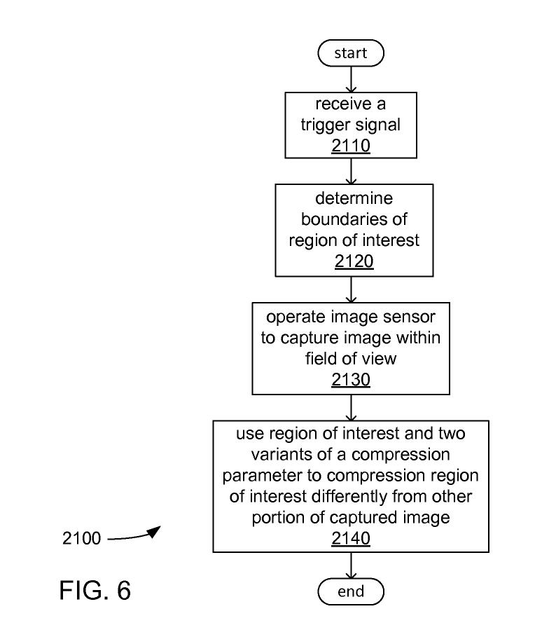

FIG. 6 illustrates one embodiment of a logic flow 2100. The logic flow 2100 may be representative of some or all of the operations executed by one or more embodiments described herein. More specifically, the logic flow 2100 may illustrate operations performed by the processor element 250 of the capture device 200 in executing at least the control routine 240.

At 2110, a capture device (e.g., the capture device 200) receives a trigger signal. As has been discussed, this could be a trigger signal to do either or both of automatically adjusting focus in preparation for capturing an image, or actually capturing an image.

At 2120, the capture device determines the boundaries of a region of interest within the field of view of provided to its image sensor. As has been discussed, these boundaries may be determined as a byproduct of operation of a distance sensor determining the distance, size and/or location of an object in the field of view that is either the closest to the capture device or that is in the center of the field of view. Alternatively, these boundaries may be determined as a result of execution of any of a variety of possible algorithms for identifying a specific type of object in the field of view, including and not limited to faces. In another alternative, these boundaries may be indicated to the capture device in signals received by the capture device, including possibly signals indicative of operation of controls of the capture device by its operator to specify these boundaries. As has additionally been discussed, the boundaries of the region of interest may be selected to align with boundaries of adjacent macroblocks of pixels making up the image where a compression encoding algorithm that organizes the pixels into macroblocks is used.

At 2130, the capture device operates its image sensor to capture an image of what is visible within the field of view provided to the image sensor. As has been discussed, aspects of the field of view are determined by characteristics of both the image sensor and any optics that may be interposed between the image sensor and the scene in the field of view. As has also been discussed, the captured image may either be a single still image or an image serving as one frame of multiple frames making up a portion of captured motion video.

At 2140, the capture device compresses data representing the captured image (e.g., the captured data 135) making use of an indication of the boundaries of the region of interest such that portions of that data representing the portion of the image within the region of interest are compressed to a lesser degree than portions of that data representing a portion of the image outside of the region of interest. In effect, less data per pixel associated with pixels of the portion of the image within the region of interest is lost than for pixels associated with a portion of the image outside the region of interest. In this way, a greater degree of per-pixel detail is preserved in the region of interest than outside it.

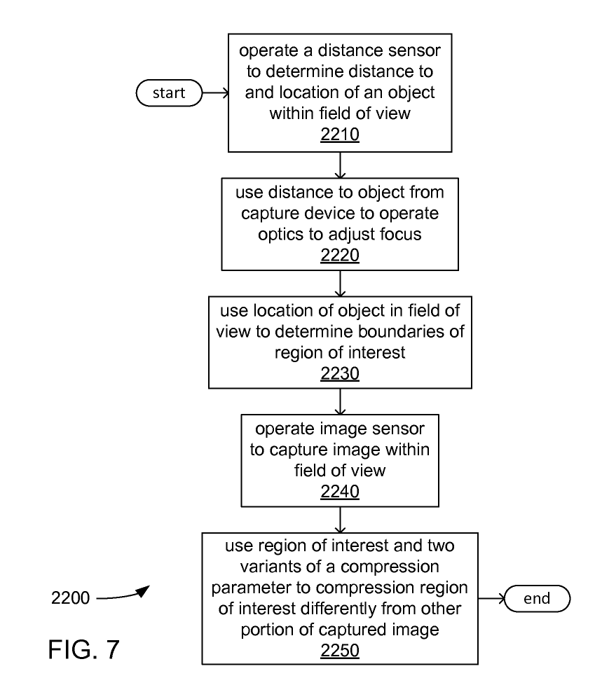

FIG. 7 illustrates one embodiment of a logic flow 2200. The logic flow 2200 may be representative of some or all of the operations executed by one or more embodiments described herein. More specifically, the logic flow 2200 may illustrate operations performed by the processor element 250 of the capture device 200 in executing at least the control routine 240.

At 2210, a capture device (e.g., the capture device 200) operates its distance sensor to determine the distance to an object and the object's location within a field of view of its image sensor. As has been discussed, this may be an object selected as a result of being closest to the capture device, or alternatively, may be an object selected as a result of being in the center of the field of view. As has also been discussed, the distance sensor may be based on any of a wide variety of technologies, including and not limited to sound waves, light beams, etc.

At 2220, the capture device uses the determined distance to the object from the capture device to operate its optics to adjust focus in preparation for capturing an image. As has been discussed, the optics may include one or more lenses and/or reflective surfaces that are able to be moved by motors and/or other mechanisms, and/or are themselves alterable in shape to alter the focus.

At 2230, the capture device determines the boundaries of a region of interest within the field of view of provided to its image sensor using at least the location of the object within the field of view. However, as has also been discussed, size and/or shape of the object may also be used in determining these boundaries.

At 2240, the capture device operates its image sensor to capture an image of what is visible within the field of view provided to the image sensor. And, at 2250, the capture device compresses data representing the captured image (e.g., the captured data 135) making use of an indication of the boundaries of the region of interest such that portions of that data representing the portion of the image within the region of interest are compressed to a lesser degree than portions of that data representing a portion of the image outside of the region of interest.

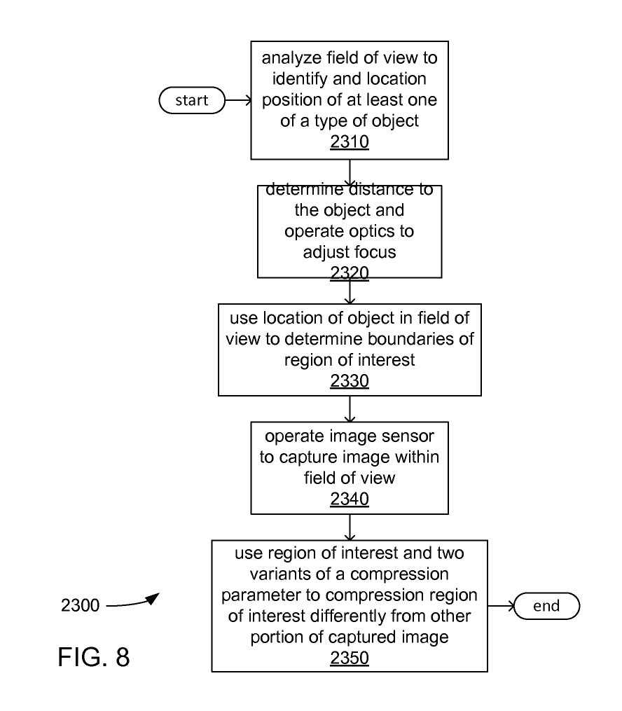

FIG. 8 illustrates one embodiment of a logic flow 2300. The logic flow 2300 may be representative of some or all of the operations executed by one or more embodiments described herein. More specifically, the logic flow 2300 may illustrate operations performed by the processor element 250 of the capture device 200 in executing at least the control routine 240.

At 2310, a capture device (e.g., the capture device 200) employs one or more of a variety of possible algorithms to analyze objects visible in the field of view of its sensor to attempt to identify one or more specific types of objects, including and not limited to faces. As previously discussed, use of such algorithms are based on assumption that one or more particular types of objects will be the subject(s) of interest to an operator of the capture device.

At 2320, the capture device operates its distance sensor to determine the distance to the identified object, and uses the determined distance to that object from the capture device to operate its optics to adjust focus in preparation for capturing an image. As has been discussed, the distance sensor may be based on any of a variety of technologies to detect a distance to an object, and the optics may employ any of a variety of mechanisms to either move or alter the shape of one or more lenses or reflective surfaces.

At 2330, the capture device determines the boundaries of a region of interest within the field of view of provided to its image sensor using at least the location of the identified object within the field of view. However, as has also been discussed, size and/or shape of that object may also be used in determining these boundaries.

At 2340, the capture device operates its image sensor to capture an image of what is visible within the field of view provided to the image sensor. And, at 2350, the capture device compresses data representing the captured image (e.g., the captured data 135) making use of an indication of the boundaries of the region of interest such that portions of that data representing the portion of the image within the region of interest are compressed to a lesser degree than portions of that data representing a portion of the image outside of the region of interest.

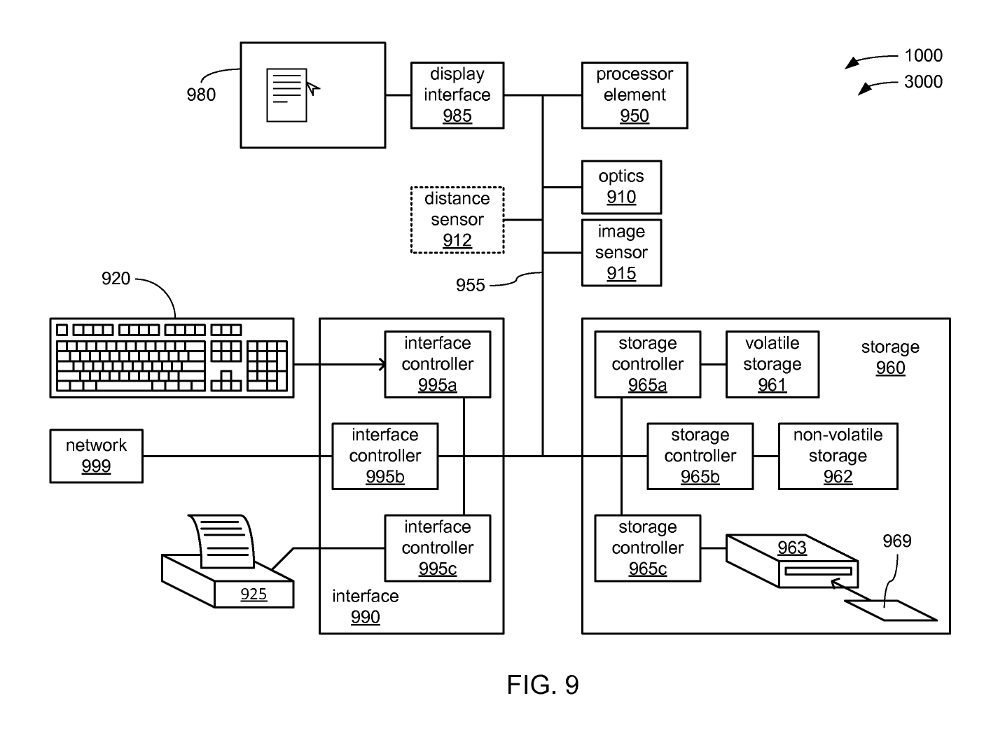

FIG. 9 illustrates an embodiment of an exemplary processing architecture 3000 suitable for implementing various embodiments as previously described. More specifically, the processing architecture 3000 (or variants thereof) may be implemented as part of one or more of the computing devices 200 and 700. It should be noted that components of the processing architecture 3000 are given reference numbers in which the last two digits correspond to the last two digits of reference numbers of components earlier depicted and described as part of each of the computing devices 200 and 700. This is done as an aid to correlating such components of whichever ones of the computing devices 200 and 700 may employ this exemplary processing architecture in various embodiments.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor element, the processor element itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3000, a computing device incorporates at least a processor element 950, a storage 960, an interface 990 to other devices, and coupling 955. Depending on various aspects of a computing device implementing the processing architecture 3000, including its intended use and/or conditions of use, such a computing device may further incorporate additional components, such as without limitation, optics 910, a distance sensor 912 and/or an image sensor 915.

The coupling 955 incorporates one or more buses, point-to-point interconnects, transceivers, buffers, crosspoint switches, and/or other conductors and/or logic that communicatively couples at least the processor element 950 to the storage 960. The coupling 955 may further couple the processor element 950 to one or more of the interface 990 and the display interface 985 (depending on which of these and/or other components are also present). With the processor element 950 being so coupled by couplings 955, the processor element 950 is able to perform the various ones of the tasks described at length, above, for whichever ones of the computing devices 200 and 700 implement the processing architecture 3000. The coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor element 950 (corresponding to one or more of the processor elements 250, 250a, 250b and 750) may include any of a wide variety of commercially available processors, employing any of a wide variety of technologies and implemented with one or more cores physically combined in any of a number of ways.

As previously discussed, the storage 960 (corresponding to one or more of the storages 260, 260a, 260b and 760) may include one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor element 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of removable machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may include an article of manufacture in the form of a machine-readable storage media on which a routine comprising a sequence of instructions executable by the processor element 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor element 950 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor element 950 as that routine is executed.

As previously discussed, the interface 990 (corresponding to one or more of the interfaces 390 and 790) may employ any of a variety of signaling technologies corresponding to any of a variety of communications technologies that may be employed to communicatively couple a computing device to one or more other devices. Again, one or both of various forms of wired or wireless signaling may be employed to enable the processor element 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network comprising one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3000 may also incorporate the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

More generally, the various elements of the computing devices 200 and 700 may include various hardware elements, software elements, or a combination of both. Examples of hardware elements may include devices, logic devices, components, processors, microprocessors, circuits, processor elements, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of an apparatus to compress an image includes an image sensor to capture the image as captured data; and logic to determine first boundaries of a region of interest within the image; compress a first portion of the captured data that represents a first portion of the image within the region of interest with a first parameter; and compress a second portion of the captured data that represents a second portion of the image outside the region of interest with a second parameter, the first and second parameters selected to compress the second portion of the captured data to a greater degree than the first portion of the captured data.

The above example of an apparatus in which the logic is to analyze a field of view of the image sensor to identify an object, and determine the first boundaries to encompass the object within the region of interest.

Either of the above examples of an apparatus in which the object includes a face.

Any of the above examples of an apparatus in which the apparatus includes a distance sensor to determine a distance to the object and optics interposed between the image sensor and the object, and the logic is to operate the optics to adjust a focus in response to the distance.

Any of the above examples of an apparatus in which the apparatus includes a distance sensor to determine a distance to an object at a center of a field of view of the image sensor and optics interposed between the image sensor and the object, and the logic is to operate the optics adjust a focus in response to the distance and to determine the first boundaries to encompass the object within the region of interest.

Any of the above examples of an apparatus in which the apparatus includes controls, and the logic is to receive signals indicative of operation of the controls to adjust the first boundaries.

Any of the above examples of an apparatus in which the apparatus includes a display and the logic is to visually present a field of view of the image sensor and the first boundaries on the display.

Any of the above examples of an apparatus in which the second parameter differs from the first parameter in specifying one of a lower color depth than the first parameter, a different color encoding than the first parameter, a different quality setting than the first parameter, a selection of lossy compression rather than a lossless compression selection of the first parameter, or a higher compression ration than the first parameter.

Any of the above examples of an apparatus in which the logic is to align the first boundaries with second boundaries of adjacent macroblocks associated with a compression encoding algorithm used in compressing the first and second portions of the captured data.

Any of the above examples of an apparatus in which the apparatus includes an interface to couple the logic to a network to transmit a compressed data created from the compression of the first and second portions of the captured data to a computing device.

An example of another apparatus to compress an image includes an interface to receive via a network a captured data representing the captured image and a region of interest data indicating first boundaries of a region of interest; and logic to compress a first portion of the captured data that represents a first portion of the captured image within the region of interest with a first parameter, and compress a second portion of the captured data that represents a second portion of the captured image outside the region of interest with a second parameter, the first and second parameters selected to differ to compress the first portion of the captured data to lose data per pixel to a lesser degree than the second portion of the captured data.

The above example of another apparatus in which the apparatus includes controls, and the logic is to receive signals indicative of operation of the controls to adjust the first boundaries.

Either of the above examples of another apparatus in which the apparatus includes a display, and the logic is to visually present a field of view of the image sensor and the first boundaries on the display.

Any of the above examples of another apparatus in which the second parameter differs from the first parameter in specifying one of a lower color depth than the first parameter, a different color encoding than the first parameter, a different quality setting than the first parameter, a selection of lossy compression rather than a lossless compression selection of the first parameter, or a higher compression ration than the first parameter.

Any of the above examples of another apparatus in which the logic is to align the first boundaries with second boundaries of adjacent macroblocks associated with a compression encoding algorithm used in compressing the first and second portions of the captured data.

Any of the above examples of another apparatus in which the logic is to transmit a compressed data created from the compression of the first and second portions of the captured data via the network to a computing device.

An example of a computer-implemented method of compressing a captured image includes capturing the captured image as captured data representing the captured image, determining first boundaries of a region of interest within the captured image, compressing a first portion of the captured data representing a first portion of the captured image within the region of interest with a first parameter, and compressing a second portion of the captured data representing a second portion of the image outside the region of interest with a second parameter corresponding to the first parameter, the first and second parameters selected to differ to compress the second portion of the captured data to a greater degree than the first portion of the captured data.

The above example of a computer-implemented method in which the method includes analyzing a field of view of an image sensor operated to capture the image to identify an object, and determining the first boundaries to encompass the object within the region of interest.

Either of the above examples of a computer-implemented method in which the object includes a face.

Any of the above examples of a computer-implemented method in which the method includes determining a distance to the object, and operating optics interposed between the image sensor and the object to adjust a focus in response to the distance.

Any of the above examples of a computer-implemented method in which the method includes determining a distance to an object at a center of a field of view of an image sensor operated to capture the image, operating optics interposed between the image sensor and the object to adjust a focus in response to the distance, and determining the first boundaries to encompass the object within the region of interest.

Any of the above examples of a computer-implemented method in which the method includes visually presenting a field of view of an image sensor operated to capture the image and the first boundaries on a display, and receiving signals indicative of operation of controls to adjust the first boundaries.

Any of the above examples of a computer-implemented method in which the second parameter differs from the first parameter in specifying one of a lower color depth than the first parameter, a different color encoding than the first parameter, a different quality setting than the first parameter, a selection of lossy compression rather than a lossless compression selection of the first parameter, or a higher compression ration than the first parameter.

Any of the above examples of a computer-implemented method in which the method includes aligning the first boundaries with second boundaries of adjacent macroblocks associated with a compression encoding algorithm used in compressing the first and second portions of the captured data.

Any of the above examples of a computer-implemented method in which the method includes creating a compressed data from the compression of the first and second portions of the captured data in which pixel data is organized into at least one initial pass comprising pixel data representing both the first and second portions of the captured image and at least one additional pass comprising pixel data representing the first portion of the captured image and not the second portion of the captured image.

Any of the above examples of a computer-implemented method in which the method includes transmitting a compressed data created from the compression of the first and second portions of the captured data to a computing device via a network.

An example of an apparatus includes means for performing any of the above examples of a computer-implemented method.

An example of at least one machine-readable storage medium includes instructions that when executed by a computing device, cause the computing device to receive a captured data representing a captured image and a region of interest data indicating first boundaries of a region of interest, compress a first portion of the captured data representing a first portion of the captured image within the region of interest with a first parameter, and compress a second portion of the captured data representing a second portion of the captured image outside the region of interest with a second parameter corresponding to the first parameter, the first and second parameters selected to compress the second portion of the captured data to a greater degree than the first portion of the captured data.

The above example of at least one machine-readable storage medium in which the computing device is caused to visually present a field of view of an image sensor operated to capture the captured image and the first boundaries on a display, and receive signals indicative of operation of controls to adjust the first boundaries.

Either of the above examples of at least one machine-readable storage medium in which the computing device is caused to align the first boundaries with second boundaries of adjacent macroblocks associated with a compression encoding algorithm used in compressing the first and second portions of the captured data.

Any of the above examples of at least one machine-readable storage medium in which the computing device is caused to transmit a compressed data created from the compression of the first and second portions of the captured data to another computing device via a network.

An example of still another apparatus to compress an image includes means for receiving the captured data representing a captured image and a region of interest data indicating first boundaries of a region of interest, compressing a first portion of the captured data representing a first portion of the captured image within the region of interest with a first parameter, and compressing a second portion of the captured data representing a second portion of the captured image outside the region of interest with a second parameter corresponding to the first parameter, the first and second parameters selected to compress the second portion of the captured data to a greater degree than the first portion of the captured data.

The above example of still another apparatus in which the apparatus includes means for visually presenting a field of view of an image sensor operated to capture the captured image and the first boundaries on a display, and receiving signals indicative of operation of controls to adjust the first boundaries.

Either of the above examples of still another apparatus in which the apparatus includes means for aligning the first boundaries with second boundaries of adjacent macroblocks associated with a compression encoding algorithm used in compressing the first and second portions of the captured data.

Any of the above examples of still another apparatus in which the apparatus includes means for transmitting a compressed data created from the compression of the first and second portions of the captured data to another computing device via a network.

1.-25. (canceled)

26. An apparatus comprising:
an image sensor to capture an image as captured data; and
logic to:
determine first boundaries of a region of interest within the image;
compress a first portion of the captured data that represents a first portion of the image within the region of interest with a first parameter; and
compress a second portion of the captured data that represents a second portion of the image outside the region of interest with a second parameter, the first and second parameters selected to compress the second portion of the captured data to a greater degree than the first portion of the captured data.

27. The apparatus of claim 26, the logic to:
analyze a field of view of the image sensor to identify an object; and
determine the first boundaries to encompass the object within the region of interest.

28. The apparatus of claim 27, comprising:
a distance sensor to determine a distance to the object; and
optics interposed between the image sensor and the object, the logic to operate the optics to adjust a focus in response to the distance.

29. The apparatus of claim 26, comprising:
a distance sensor to determine a distance to an object at a center of a field of view of the image sensor; and
optics interposed between the image sensor and the object, the logic to operate the optics adjust a focus in response to the distance and to determine the first boundaries to encompass the object within the region of interest.

30. The apparatus of claim 26, comprising controls, the logic to receive signals indicative of operation of the controls to adjust the first boundaries.

31. The apparatus of claim 30, comprising a display, the logic to visually present a field of view of the image sensor and the first boundaries on the display.

32. The apparatus of claim 26, the logic to align the first boundaries with second boundaries of adjacent macroblocks associated with a compression encoding algorithm used in compressing the first and second portions of the captured data.

33. An apparatus comprising:
an interface to receive via a network a captured data representing a captured image and a region of interest data indicating first boundaries of a region of interest; and
logic to:
compress a first portion of the captured data that represents a first portion of the captured image within the region of interest with a first parameter; and
compress a second portion of the captured data that represents a second portion of the captured image outside the region of interest with a second parameter, the first and second parameters selected to differ to compress the first portion of the captured data to lose data per pixel to a lesser degree than the second portion of the captured data.

34. The apparatus of claim 33, comprising controls, the logic to receive signals indicative of operation of the controls to adjust the first boundaries.

35. The apparatus of claim 34, comprising a display, the logic to visually present a field of view of the image sensor and the first boundaries on the display.

36. The apparatus of claim 33, the second parameter differing from the first parameter in specifying one of a lower color depth than the first parameter, a different color encoding than the first parameter, a different quality setting than the first parameter, a selection of lossy compression rather than a lossless compression selection of the first parameter, or a higher compression ration than the first parameter.

37. The apparatus of claim 33, the logic to align the first boundaries with second boundaries of adjacent macroblocks associated with a compression encoding algorithm used in compressing the first and second portions of the captured data.

38. The apparatus of claim 33, the logic to transmit a compressed data created from the compression of the first and second portions of the captured data via the network to a computing device.

39. A computer-implemented method comprising:
capturing an image as captured data representing a captured image;
determining first boundaries of a region of interest within the captured image;
compressing a first portion of the captured data representing a first portion of the captured image within the region of interest with a first parameter; and
compressing a second portion of the captured data representing a second portion of the image outside the region of interest with a second parameter corresponding to the first parameter, the first and second parameters selected to differ to compress the second portion of the captured data to a greater degree than the first portion of the captured data.

40. The computer-implemented method of claim 39 comprising:
analyzing a field of view of an image sensor operated to capture the image to identify an object; and
determining the first boundaries to encompass the object within the region of interest.

41. The computer-implemented method of claim 40, the object comprising a face.

42. The computer-implemented method of claim 40, comprising:
determining a distance to the object; and
operating optics interposed between the image sensor and the object to adjust a focus in response to the distance.

43. The computer-implemented method of claim 39, comprising:
determining a distance to an object at a center of a field of view of an image sensor operated to capture the image;
operating optics interposed between the image sensor and the object to adjust a focus in response to the distance; and
determining the first boundaries to encompass the object within the region of interest.

44. The computer-implemented method of claim 39, comprising:
visually presenting a field of view of an image sensor operated to capture the image and the first boundaries on a display; and
receiving signals indicative of operation of controls to adjust the first boundaries.

45. The computer-implemented method of claim 39, comprising aligning the first boundaries with second boundaries of adjacent macroblocks associated with a compression encoding algorithm used in compressing the first and second portions of the captured data.

46. The computer-implemented method of claim 39, comprising creating a compressed data from the compression of the first and second portions of the captured data in which pixel data is organized into at least one initial pass comprising pixel data representing both the first and second portions of the captured image and at least one additional pass comprising pixel data representing the first portion of the captured image and not the second portion of the captured image.

47. At least one machine-readable storage medium comprising instructions that when executed by a computing device, cause the computing device to:
receive a captured data representing a captured image and a region of interest data indicating first boundaries of a region of interest;
compress a first portion of the captured data representing a first portion of the captured image within the region of interest with a first parameter; and
compress a second portion of the captured data representing a second portion of the captured image outside the region of interest with a second parameter corresponding to the first parameter, the first and second parameters selected to compress the second portion of the captured data to a greater degree than the first portion of the captured data.

48. The at least one machine-readable storage medium of claim 47, the computing device caused to:
visually present a field of view of an image sensor operated to capture the captured image and the first boundaries on a display; and
receive signals indicative of operation of controls to adjust the first boundaries.

49. The at least one machine-readable storage medium of claim 47, the computing device caused to align the first boundaries with second boundaries of adjacent macroblocks associated with a compression encoding algorithm used in compressing the first and second portions of the captured data.

50. The at least one machine-readable storage medium of claim 47, the computing device caused to transmit a compressed data created from the compression of the first and second portions of the captured data to another computing device via a network.
